(19) United States
(12) Patent Application Publication
(10) Pub. No.: US 2026/0278819 A1
(43) Pub. Date: Sep. 17, 2026

(54) DETECTION DEVICE

(71) Applicant: Japan Display Inc., Tokyo (JP)

(72) Inventors: Kaoru ITO, Tokyo (JP); Norio MAMBA, Tokyo (JP); Daichi ABE, Tokyo (JP); Yoshihiro SEKIGUCHI, Tokyo (JP)

(21) Appl. No.: 19/561,827

(22) Filed: Mar. 10, 2026

(30) Foreign Application Priority Data
Mar. 13, 2025 (JP) 2025-040308

(51) Int. Cl. G06T 7/586; G01B 11/255; G06T 7/62

(52) U.S. Cl. CPC G06T 7/586; G01B 11/255; G06T 7/62; G06T 2207/10024

(57) ABSTRACT

According to an aspect, a detection device includes: a light source; a planar optical sensor; an object placement part allowing a culture medium accommodated in a dish to be placed such that the culture medium is interposed between the light source and the planar optical sensor; and a processor. The processor is configured to determine a boundary between a proliferation area and a non-proliferation area of culture targets based on a degree of light transmission of the culture medium. The boundary is in a position closest to a position where a rate of change in the degree of the light transmission is relatively highest among positions where the rate of change in the degree of the light transmission is equal to or less than a predetermined value within an area where the degree of the light transmission changes from a relatively higher side toward a relatively lower side.

### CROSS-REFERENCE TO RELATED APPLICATION

This application claims the benefit of priority from Japanese Patent Application No. 2025-040308 filed on Mar. 13, 2025, the entire contents of which are incorporated herein by reference.

### BACKGROUND

### 1. Technical Field

What is disclosed herein relates to a detection device.

### 2. Description of the Related Art

Devices are known that acquire an image by imaging a Petri dish in which a culture medium (e.g., agar) for culturing culture targets such as bacteria is formed, and detect colonies of the culture targets formed on the culture medium from the image (for example, Japanese Patent Application Laid-open Publication No. 2012-080802).

A boundary between a proliferation area of the culture targets that is indicated by the occurrence of the colonies and a non-proliferation area where the colonies are not occurring on the culture medium does not always appear as a clear line in the image. Such a boundary is desired to be more clearly identified even when it does not appear as a clear line.

For the foregoing reasons, there is a need for a detection device capable of more accurately detecting the boundary between the proliferation area and the non-proliferation area of the culture targets.

### SUMMARY

According to an aspect, a detection device includes: a light source configured to emit light; a planar optical sensor in which a plurality of optical sensors configured to detect the light from the light source are two-dimensionally arranged; an object placement part provided so as to allow an object to be detected to be placed such that the object to be detected is interposed between the light source and the planar optical sensor; and a processor configured to perform operation control of the light source and the planar optical sensor and processing based on outputs of the optical sensors. The object to be detected is a culture medium accommodated in a dish of a container. The planar optical sensor is configured to output data reflecting an intensity of the light that has been emitted from the light source and reached the optical sensors through the object to be detected. The processor is configured to determine a boundary between a proliferation area and a non-proliferation area of culture targets based on a level of a degree of light transmission of the culture medium that varies according to a degree of proliferation of the culture targets that are cultured on the culture medium. The boundary is in a position that is closest to a position where a rate of change in the degree of light transmission of the culture medium is relatively highest among positions where the rate of change in the degree of light transmission of the culture medium is equal to or less than a predetermined value within an area where the degree of light transmission of the culture medium changes from a relatively higher side toward a relatively lower side.

### BRIEF DESCRIPTION OF THE DRAWINGS

FIG. 1 is a diagram illustrating a main configuration of a detection device;

FIG. 2 is a diagram illustrating a configuration example of a detection area and a wiring area;

FIG. 3 is a circuit diagram illustrating a circuit configuration of an optical sensor;

FIG. 4 illustrates schematic views illustrating configuration examples of a light source;

FIG. 5 is a schematic diagram schematically illustrating a configuration example of a detection system;

FIG. 6 is a schematic diagram illustrating a relation between one detection device and an external configuration;

FIG. 7 is a schematic view illustrating a structure of various parts including main components of the detection device and an object to be detected that is placed on the detection device;

FIG. 8 is a schematic view highlighting a configuration in the region of a culture medium in the object to be detected located in a detection area SA in plan view;

FIG. 9 is a schematic view illustrating an example of a state after an inhibition circle has appeared in the configuration illustrated in FIG. 8;

FIG. 10 is a diagram explaining the Hough transform;

FIG. 11 is a schematic graph illustrating a distribution of levels of Rawdata indicated by an image obtained by detecting light transmitted through the culture medium in an initial state;

FIG. 12 is a schematic graph illustrating the distribution of levels of Rawdata indicated by an image obtained by detecting the light transmitted through the culture medium after a colony has appeared;

FIG. 13 illustrates schematic diagrams for comparison between paths of light reaching a planar optical sensor in the initial state and the state after a colony has appeared;

FIG. 14 is a schematic diagram for explaining a process of calculation of gradients of points constituting a curvilinearly varying portion within a boundary area;

FIG. 15 is a flowchart of processing related to operations of the detection device;

FIG. 16 is a flowchart of an initial process; and

FIG. 17 is a flowchart of a periodic operation.

### DETAILED DESCRIPTION

The following describes an embodiment of the present disclosure with reference to the drawings. What is disclosed herein is merely an example, and the present disclosure naturally encompasses appropriate modifications easily conceivable by those skilled in the art while maintaining the gist of the present invention. To further clarify the description, the drawings may schematically illustrate, for example, widths, thicknesses, and shapes of various parts as compared with actual aspects thereof. However, they are merely examples, and interpretation of the present disclosure is not limited thereto. The same element as that illustrated in a drawing that has already been discussed is denoted by the same reference numeral through the description and the drawings, and detailed description thereof may not be repeated where appropriate.

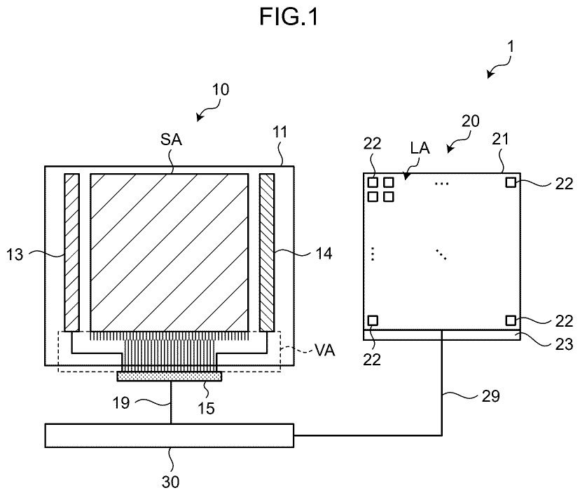

FIG. 1 is a diagram illustrating a main configuration of a detection device 1. The detection device 1 includes a planar optical sensor 10, a light source panel 20, and a control circuit 30. The planar optical sensor 10 and the light source panel 20 of the detection device 1 are coupled to the control circuit 30.

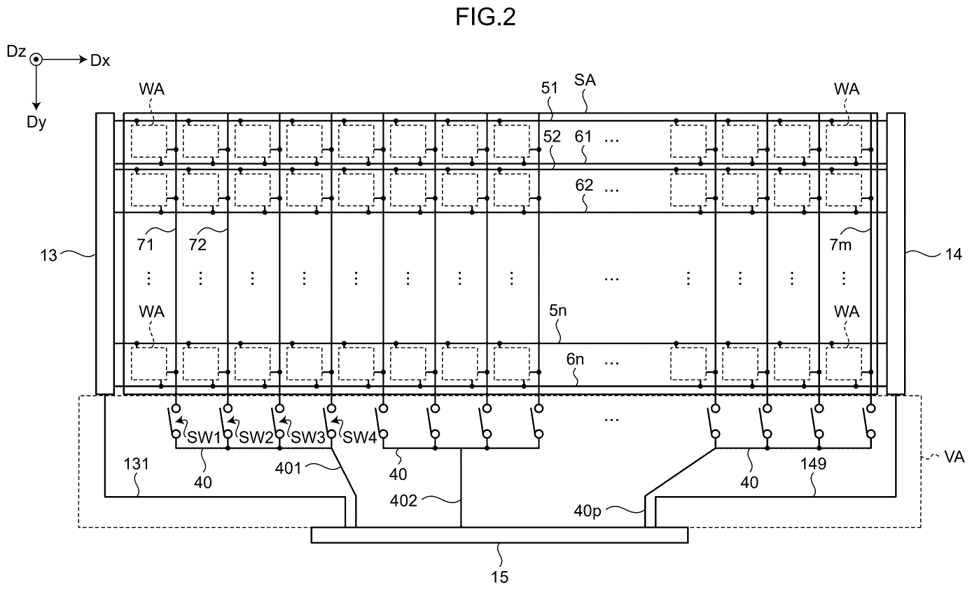

The planar optical sensor 10 is provided with a detection area SA (refer to FIG. 2) on a substrate 11. A reset circuit 13, a scan circuit 14, and a wiring area VA are provided on the substrate 11. Components on the detection area SA, the reset circuit 13, and the scan circuit 14 are coupled to a detection circuit 15 via the wiring area VA.

The light source panel 20 has a light-emitting area LA that emits light to the detection area SA. The light source panel 20 is provided with a light source 22 on a substrate 21. The light source 22 emits light. Specifically, the light source 22 includes a light-emitting element such as a light-emitting diode (LED) and is provided in the light-emitting area LA. In the example illustrated in FIG. 1, a plurality of the light sources 22 are arranged in a matrix having a row-column configuration on the substrate 21.

The light source panel 20 is provided with a light source drive circuit 23. Under the control of the control circuit 30, the light source drive circuit 23 controls turning on and off of each of the light sources 22 and the luminance thereof when being turned on. The light sources 22 may be provided to allow individual control of light emission or may be provided so as to emit light collectively.

The control circuit 30 performs various processes related to operations of the detection device 1. Specifically, the control circuit 30 is a circuit, such as a field-programmable gate array (FPGA) that can implement a plurality of functions. The control circuit 30 may have other configurations, such as an application-specific integrated circuit (ASIC). The control circuit 30 is coupled to the light source drive circuit 23 via wiring 29 and performs processing related to the lighting of the light sources 22, such as determination of lighting patterns and lighting timing of the light sources 22.

The control circuit 30 is coupled to the detection circuit 15 via wiring 19 and obtains an output from the detection circuit 15. The control circuit 30 also controls the timing of obtaining the output from the detection circuit 15, that is, the timing of operating the scan circuit 14 so as to provide a gate signal to a scan line 6. Thus, the control circuit 30 controls operations of the light sources 22 and the planar optical sensor 10. The control circuit 30 further performs processes based on outputs of a plurality of optical sensors WA. Such processes include various types of processes, such as an outline extraction process and the Hough transform, which are to be described later. Such processes also include a determination process to determine whether a colony has been formed. Such processes will be described later.

Although not illustrated in the drawings, the detection device 1 includes an analog-to-digital conversion circuit, a digital-to-analog conversion circuit, and other components. The analog-to-digital conversion circuit is a circuit for allowing the outputs from the optical sensors WA (refer to FIG. 2) transmitted via the detection circuit 15 to be handled in arithmetic processing by the control circuit 30. The digital-to-analog conversion circuit is a circuit for allowing digital signals generated by the arithmetic processing of the control circuit 30 to be used for controlling the operations of the planar optical sensor 10 and the light source panel 20. These circuits may be included, for example, in part or in whole in the detection circuit 15. These circuits may alternatively be functions performed by circuits mounted on flexible printed circuits (FPCs) provided as the wiring 19 and the wiring 29. These circuits may alternatively be mounted in other ways on the detection device 1.

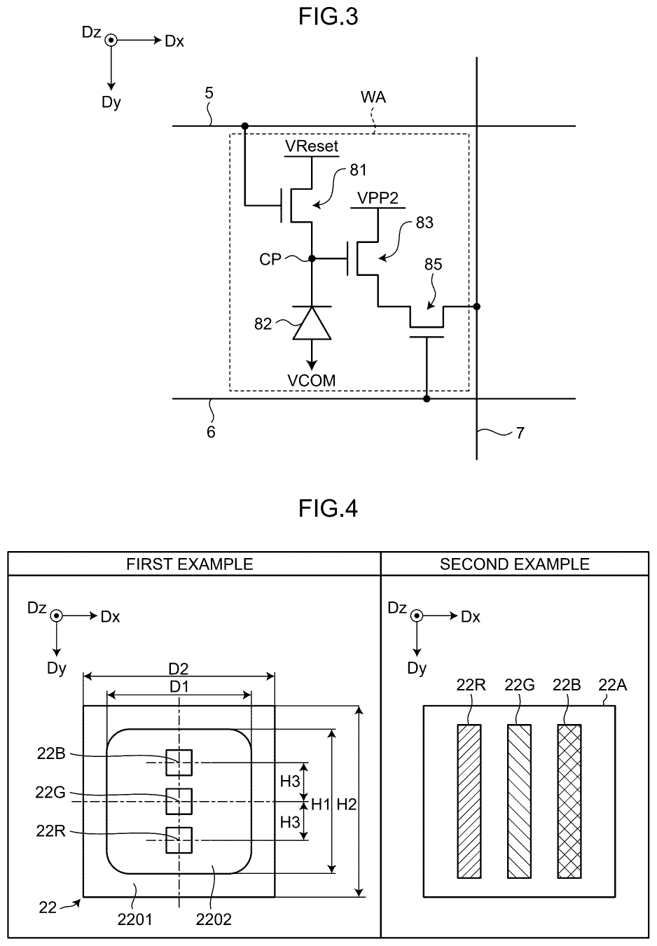

FIG. 2 is a diagram illustrating a configuration example of the detection area SA and the wiring area VA. The multiple optical sensors WA (FIG. 3) are two-dimensionally arranged in the detection area SA of the planar optical sensor 10. In the embodiment, as illustrated in FIG. 2, the optical sensors WA are arranged in a matrix having a row-column configuration along a first direction Dx and a second direction Dy. The first direction Dx is orthogonal to the second direction Dy. In the following description, the term “third direction Dz” refers to a direction orthogonal to the first direction Dx and the second direction Dy.

The reset circuit 13 is coupled to reset signal transmission lines 51, 52, . . . , 5n. Hereinafter, the term “reset signal transmission line 5” refers to any one of the reset signal transmission lines 51, 52, . . . , 5n. The reset signal transmission line 5 is wiring along the first direction Dx. In the example illustrated in FIG. 2, n reset signal transmission lines 5 are arranged in the second direction Dy. n is a natural number equal to or larger than 2. The n reset signal transmission lines 5 are each coupled, at one end in the first direction Dx, to the reset circuit 13.

The scan circuit 14 is coupled to scan lines 61, 62, . . . , 6n. Hereinafter, the term “scan line 6” refers to any one of the scan lines 61, 62, . . . , 6n. The scan line 6 is wiring along the first direction Dx. In the example illustrated in FIG. 2, n scan lines 6 are arranged in the second direction Dy. The n scan lines 6 are each coupled, at the other end in the first direction Dx, to the scan circuit 14.

As illustrated in FIG. 2, the reset signal transmission lines 5 and the scan lines 6 are alternately arranged in the second direction Dy in the detection area SA. The reset circuit 13 and the scan circuit 14 illustrated in FIGS. 1 and 2 are arranged at locations facing each other with the detection area SA interposed therebetween, but the layout of the reset circuit 13 and the scan circuit 14 is not limited to this layout and can be changed as appropriate.

Signal lines 71, 72, . . . , 7m are also provided in the detection area SA. Hereafter, the term “signal line 7” refers to any one of the signal lines 71, 72, . . . , 7m. The signal line 7 is wiring along the second direction Dy.

In the example illustrated in FIG. 2, m signal lines 7 are arranged in the first direction Dx. m is a natural number equal to or larger than 2. The m signal lines 7 are each coupled, at one end in the second direction Dy, to one of a plurality of switches (for example, a switch SW1, a switch SW2, a switch SW3, or a switch SW4) included in a multiplexer 40.

The multiplexer 40 is provided in the wiring area VA. The multiplexer 40 includes a plurality of switches. In the example illustrated in FIG. 2, the switches SW1, SW2, SW3, and SW4 are illustrated as the switches. The switches included in one multiplexer 40 are turned on (conducting state) at different times from one another. During a period when one of the switches included in one multiplexer 40 is on (conducting state), the other switches are off (non-conducting state). The number of the multiplexers 40 corresponds to the number (m) of the signal lines 7. When the number of the switches is p, m/p is sufficient as the number of the multiplexers 40. When more than one multiplexer 40 are provided, each of the multiplexers 40 is coupled to the detection circuit 15 via an individual one of wiring lines 401, 402, . . . , 40p.

The coupling between the signal lines 7 and the detection circuit 15 via the multiplexer 40 is merely exemplary and is not limited to this example. The signal lines 7 may be individually directly coupled to the detection circuit 15 in the wiring area VA. In the wiring area VA, the reset circuit 13 is coupled to the detection circuit 15 via wiring 131. In the wiring area VA, the scan circuit 14 is coupled to the detection circuit 15 via wiring 149.

In the detection of light by a photodiode (PD) 82 (refer to FIG. 3) provided in the optical sensor WA, the detection circuit 15 outputs signals to control operation timing of the reset circuit 13 and the scan circuit 14 under the control of the control circuit 30. The detection circuit 15 receives the outputs from the optical sensors WA. The detection circuit 15 converts the signals received from the optical sensors WA into data that can be interpreted by the control circuit 30 and outputs the data to the control circuit 30. The detection circuit 15 of the embodiment is a microcontroller unit (MCU).

FIG. 3 is a circuit diagram illustrating a circuit configuration of the optical sensor WA. The first direction Dx and the second direction Dy in FIG. 3 merely correspond to the directions of the reset signal transmission lines 5, the scan lines 6, and the signal lines 7, and do not exactly indicate the relative positional relation of the circuit configuration in the optical sensor WA.

As illustrated in FIG. 3, a switching element 81, the PD 82, a transistor element 83, and a switching element 85 are provided in the optical sensor WA. The PD 82 is a photodiode (PD). The switching elements 81 and 85 and the transistor element are metal-oxide semiconductor field-effect transistors (MOSFETS).

The gate of the switching element 81 is coupled to the reset signal transmission line 5. One of the source and the drain of the switching element 81 is supplied with a reset potential VReset. The other of the source and the drain of the switching element 81 is coupled to the cathode of the PD 82 and the gate of the transistor element 83. Hereinafter, the term “coupling part CP” refers to a point where the other of the source and the drain of the switching element 81 is coupled to the cathode of the PD 82 and the gate of the transistor element 83. A reference potential VCOM is supplied from the anode side of the PD 82. The potential difference between the reset potential VReset and the reference potential VCOM is set in advance, but the reset potential VReset and the reference potential VCOM may be variable. The reset potential VReset is higher than the reference potential VCOM.

The drain of the transistor element 83 serving as a source follower is supplied with an output source potential VPP2. The source of the transistor element 83 is coupled to one of the source and the drain of the switching element 85. The other of the source and the drain of the switching element 85 is coupled to the signal line 7. The gate of the switching element 85 is coupled to the scan line 6.

The reset potential VReset, the reference potential VCOM, and the output source potential VPP2 are supplied by the detection circuit 15 to the optical sensor WA based on, for example, electric power supplied via a power supply circuit (not illustrated) coupled to the detection circuit 15. The way of outputting these potentials is not limited to this way and can be changed as appropriate.

The output source potential VPP2 is set in advance. The potential on the source side of the transistor element 83 is a potential lower than the output potential of the PD 82 by a voltage (Vth) between the gate and the source of the transistor element 83. In this case, the potential on the source side of the transistor element 83 corresponds to the reset potential VReset and the reference potential VCOM. The potential of the output of the PD 82 corresponds to photovoltaic power generated by the PD 82 in response to the light detected by the PD 82 during an exposure period.

When the gate of the switching element 85 is turned on by the gate signal supplied from the scan circuit 14 via the scan line 6, the source and the drain of the switching element 85 are brought into a conducting state therebetween. This operation transmits, to the signal line 7 via the switching element 85, a signal (potential) transmitted via the transistor element 83 to the switching element 85. Thus, the output from the optical sensor WA is generated. Hereinafter, the term “gate signal” refers to the signal (potential) supplied from the scan circuit 14 via the scan line 6. The scan circuit 14 is a circuit that outputs the gate signal. As described with reference to FIGS. 2 and 3, the optical sensors WA coupled to the scan lines 6 and the signal lines 7 are arranged in a matrix having a row-column configuration in the detection area SA of the planar optical sensor 10. The scan line 6 is provided along the first direction Dx and is configured to transmit the gate signal that causes the optical sensors WA to generate the outputs. The signal line 7 is configured to transmit the outputs of the optical sensors WA along the second direction Dy.

The output of one PD 82 provided in one optical sensor WA corresponds to the intensity of the light detected by the PD 82 during the exposure period set in advance. The output of the PD 82 is reset in response to a signal supplied by the reset circuit 13 via the reset signal transmission line 5. When the signal turns on the gate of the switching element 81, the source and the drain of the switching element 81 are brought into a conducting state therebetween. This operation resets the potential of the coupling part CP to the reset potential VReset.

FIG. 4 illustrates schematic views illustrating configuration examples of the light source 22. As illustrated in FIG. 4, the light source 22 includes a first light source 22R, a second light source 22G, and a third light source 22B. The first light source 22R, the second light source 22G, and the third light source 22B emit light in different colors from one another. In the embodiment, the first light source 22R emits red (R) light. The second light source 22G emits green (G) light. The third light source 22B emits blue (B) light.

As illustrated as “First Example” in FIG. 4, the light source 22 has, for example, a light-emitting area 2202 and a frame area 2201. In the light-emitting area 2202, the first light source 22R, the second light source 22G, and the third light source 22B that are square in shape in plan view are arranged along the second direction Dy. The frame area 2201 is a frame-like area surrounding the light-emitting area 2202. A width D1 in the first direction Dx of the light-emitting area 2202 is smaller than a width D2 in the first direction Dx of the frame area 2201. A height H1 in the second direction Dy of the light-emitting area 2202 is smaller than a height H2 in the second direction Dx of the frame area 2201. The distance between the first light source 22R and the second light source 22G is a distance H3. The distance between the second light source 22G and the third light source 22B is also the distance H3. The distance H3 is less than half the height H1. In “First Example” in FIG. 4, the width D1 is equal to the height H1, and the width D2 is equal to the height H2, but at least one of the widths may differ from a corresponding one of the heights. The light source 22 may be replaced with a light source of another form, specifically, such as a light source 22A illustrated in “Second Example” in FIG. 4. In the light source 22A, the longitudinal directions of the first light source 22R, the second light source 22G, and the third light source 22B are along the second direction Dy, and the first light source 22R, the second light source 22G, and the third light source 22B are arranged in this order from one side toward the other side in the first direction Dx. First Example and Second Example in FIG. 4 are exemplary forms of the light source according to the present disclosure, which is not limited to these examples. The shapes of the first light source 22R, the second light source 22G, and the third light source 22B in plan view and the positional relation between the first light source 22R, the second light source 22G, and the third light source 22B can be changed as appropriate. The term “plan view” refers to a front view of a plane along the first direction Dx and the second direction Dy (Dx-Dy plane).

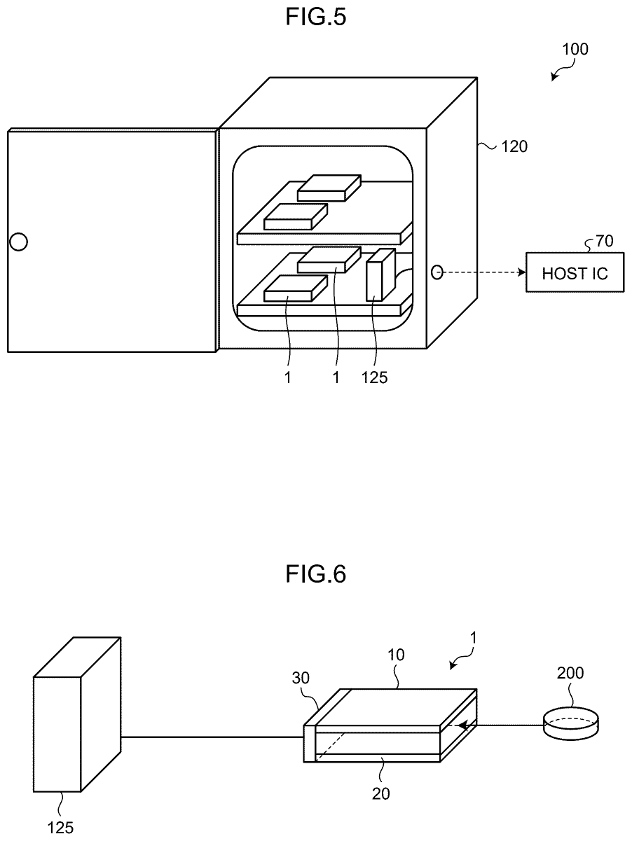

FIG. 5 is a schematic diagram schematically illustrating a configuration example of a detection system 100 including the detection device 1. As illustrated in FIG. 5, the detection system 100 includes a plurality of the detection devices 1, a host integrated circuit (IC) 70, and a coupling circuit 125. The detection devices 1 are electrically coupled to the common host IC 70 via the coupling circuit 125.

An incubator 120 illustrated in FIG. 5 is maintained such that an environment (temperature, humidity, and the like) therein is suitable for culturing at an object to be detected 200 while a door is closed. The detection devices 1 are placed in the incubator 120.

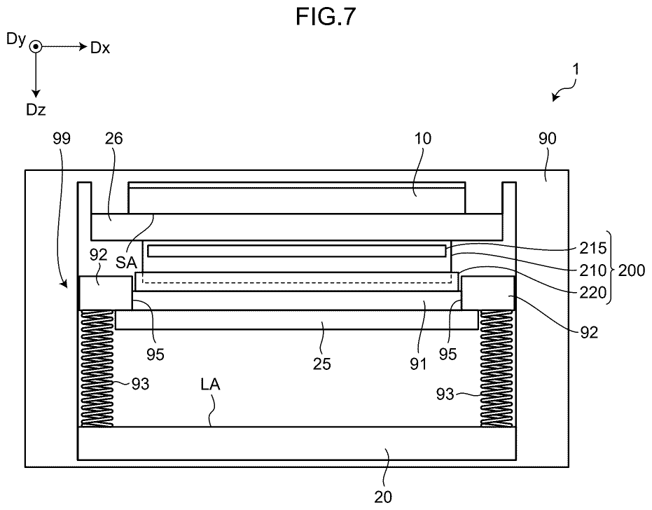

FIG. 6 is a schematic diagram illustrating a relation between one of the detection devices 1 and an external configuration. As illustrated in FIG. 6, the detection device 1 is coupled to the coupling circuit 125 by coupling the control circuit 30 to the coupling circuit 125. As illustrated in FIG. 6 and FIG. 7, which is to be described later, the planar optical sensor 10 faces the light source panel 20. The object to be detected 200 can be placed between the planar optical sensor 10 and the light source panel 20.

FIG. 6 only schematically illustrates a rough relation between the planar optical sensor 10, the light source panel 20, and the object to be detected 200. A specific structure for placing the object to be detected 200 between the planar optical sensor 10 and the light source panel 20 will be described with reference to FIG. 7.

FIG. 7 is a schematic view illustrating a structure of various parts including main components of the detection device 1 and the object to be detected 200 placed on the detection device 1. The object to be detected 200 is a culture medium 215 (e.g., agar) accommodated in a dish 210 of a container. The container further includes a lid 220. The dish 210 is specifically a Petri dish. The lid 220 is a cover of the dish 210. As illustrated in FIG. 7 to be explained later, the inner diameter of an annular sidewall of the lid 220 is equal to or more than the outer diameter of the annular sidewall of the dish 210. That is, the lid 220 has a cylindrical inner circumferential wall that covers a cylindrical outer circumferential wall of the dish 210 from the outside. The culture medium 215 is a culture medium capable of culturing the colony. Hereinafter, the term simply called “colony” refers to a colony of culture targets that have been cultured on the culture medium 215 of the object to be detected 200. The culture targets are, for example, biological tissues or microorganisms, which are assumed to be cultured on the culture medium 215. The culture medium 215 has a light-transmitting property with its degree of light transmission varying depending on the presence or absence of the colony and the thickness of the colony. The object to be detected 200 is placed on a light-transmitting member 91. The light-transmitting member 91 is a plate-like member made of colorless glass or a light-transmitting colorless synthetic resin.

The light-transmitting member 91 is a circular member having a diameter that can accommodate therein the object to be detected 200 in plan view. The light-transmitting member 91 has a light-transmitting area that can accommodate therein the object to be detected 200 between the planar optical sensor 10 and the light source panel 20. The light-transmitting member 91 is in contact with a light-blocking member 92 at the outer peripheral edge. The light-blocking member 92 is a plate-like member into which the light-transmitting member 91 is fitted. The light-blocking member 92 has a light-blocking property.

In the embodiment, a diffusion plate 25 is provided on the light source panel 20 side of the light-transmitting member 91. The diffusion plate 25 is an optical member that diffuses light. The diffusion plate 25 is located to be interposed between the light-transmitting member 91 and the light-emitting area LA of the light source panel 20. When the diffusion plate 25 receives the light emitted from the light-emitting area LA from the light source panel 20 side, the diffusion plate 25 further diffuses the traveling direction of the light as the light is transmitted toward the light-transmitting member 91. This diffusion can uniform, in plan view, the light from the light-emitting area LA formed by a set of the light sources 22 that are two-dimensionally arranged.

As illustrated in FIG. 7, in the embodiment, an elastic member 93 is provided between the light-blocking member 92 and the light source panel 20. The elastic member 93 has elasticity to urge the light-blocking member 92 toward the planar optical sensor 10. Specifically, the elastic member 93 is a cylindrical compression coil spring, as illustrated, for example, in FIG. 7. The object to be detected 200 placed on the light-transmitting member 91 is pressed against a member 26 provided between the planar optical sensor 10 and the light-transmitting member 91 by an urging force applied to the light-blocking member 92 by the elastic member 93. In the embodiment, an object placement part 99 is configured with the light-transmitting member 91, the light-blocking member 92, and the elastic member 93. In other words, the object placement part 99 includes the light-transmitting member 91 that is a light-transmitting member on which the object to be detected is placed, and the light-blocking member 92 that is a light-blocking member supporting the light-transmitting member from the outer periphery. The diameter of a circle of an edge 95, that is, a boundary between the light-transmitting member 91 and the light-blocking member 92, is larger than the diameter of a circle of the edge of the dish 210. That is, the culture medium 215 is positioned inside the edge 95.

The member 26 serves as an optical member that limits the light that is emitted from the light-emitting area LA of the light source panel 20 and reaches the planar optical sensor 10. Specifically, the member 26 includes any of a plate-shaped louver, cylindrical openings, and microlenses. In the plate-shaped louver, a plurality of plate-like structures with plate surfaces extending along the third direction Dz are arranged in parallel. The structures are preferably made of a material having a strong light-absorbing property. The member 26 is provided along a plane (Dx-Dy plane) orthogonal to the third direction Dz. The cylindrical openings penetrate the member 26 in the third direction Dz with respect to the base of the member 26. The base is preferably made of a material having a strong light-absorbing property. The microlenses are small lenses having an optical axis along the third direction Dz. The base of the member 26 that supports the microlenses is preferably made of a material having a strong light-absorbing property. Regardless of what shape the member 26 has, the member 26 as the optical member is provided in order to limit the traveling direction of the light emitted from the light sources 22 and reaching the planar optical sensor 10 to the third direction Dz or a direction having a shallower inclination angle with respect to the third direction Dz.

A housing 90 maintains a configuration in which the light-emitting area LA of the light source panel 20 and the detection area SA of the planar optical sensor 10 face in the third direction Dz. The housing 90 is a light-blocking housing provided so as to accommodate therein in advance the light source panel 20, the elastic member 93, the diffusion plate 25, the light-transmitting member 91, the light-blocking member 92, the member 26, and the planar optical sensor 10. Placing the object to be detected 200 between the member 26 and the light-transmitting member 91 establishes the positional relation among the components illustrated in FIG. 7. In the embodiment, the object to be detected 200 is placed on the light-transmitting member 91 so that the lid 220 side of the object to be detected 200 contacts the light-transmitting member 91. That is, the object to be detected 200 is placed between the planar optical sensor 10 and the light source panel 20 such that the lid 220 is located relatively below and the dish 210 is located relatively above.

As described above with reference to FIG. 7, the detection device 1 of the embodiment has a structure that allows the object to be detected 200 to be placed so as to be interposed between the planar optical sensor 10 and the light source panel 20. In the placed object to be detected 200, the bottom surface of the dish 210 with the culture medium 215 therein extends along the detection area SA of the planar optical sensor 10 and the light-emitting area LA of the light source panel 20.

The light emitted from the light-emitting area LA of the light source panel 20 is diffused by the diffusion plate 25, passes through the light-transmitting member 91, the object to be detected 200, and the optical member 26, and reaches the detection area SA of the planar optical sensor 10. Thus, the planar optical sensor 10 can be said to be configured to output data reflecting the intensity of light that has been emitted from the light source 22 and reached the optical sensors WA through the object to be detected 200. The data herein is data based on a set of the outputs from the optical sensors WA, and is, for example, an image to be described later. The intensity of the light reaching the detection area SA is affected by the degree of light transmission depending on the state of the culture medium 215 and objects placed on the culture medium 215.

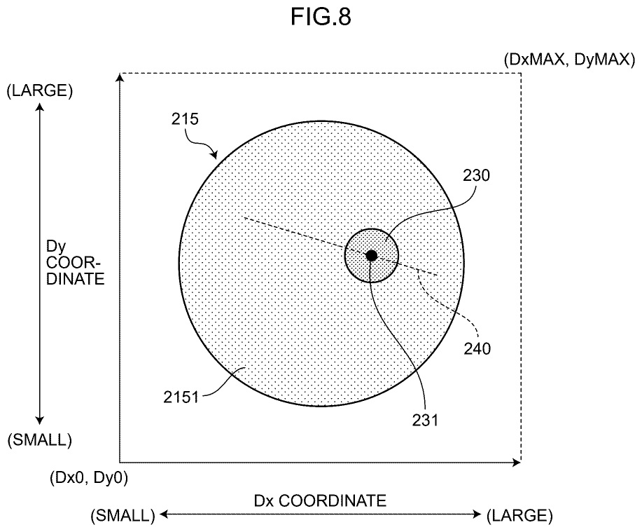

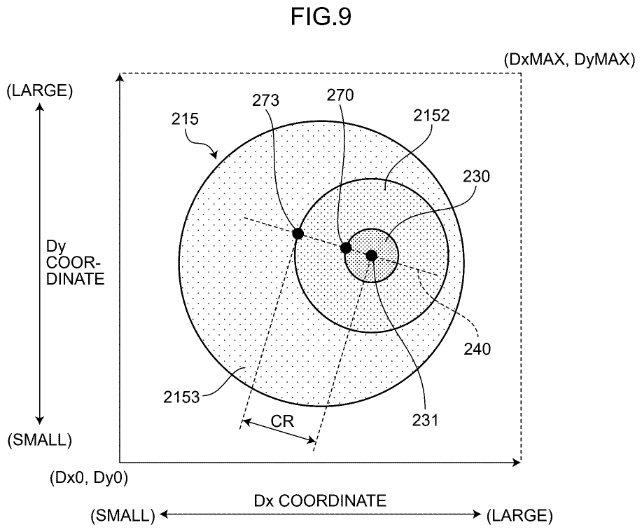

FIG. 8 is a schematic view highlighting a configuration in the region of the culture medium 215 in the object to be detected 200 located in the detection area SA in plan view. In the description with reference to FIG. 8 and FIG. 9 to be described later, the optical sensors WA arranged in the detection area SA are individually distinguished by Dx and Dy coordinates. Specifically, the coordinates of the optical sensor WA positioned at one of the four vertices of the rectangular detection area SA are denoted as (Dx0, Dy0), and the coordinates of the optical sensor WA positioned at the diagonal vertex of the one vertex are denoted as (DxMAX, DyMAX). Among the Dx coordinates for distinguishing the positions of the optical sensors WA arranged in the first direction Dx, “Dx0” denotes the smallest Dx coordinate and “DxMAX” denotes the largest Dx coordinate. Among the Dy coordinates for distinguishing the locations of the optical sensors WA arranged in the second direction Dy, “Dy0” denotes the smallest Dy coordinate and “DyMAX” denotes the largest Dy coordinate.

As illustrated in FIG. 8, in the embodiment, a disc 230 is placed on the culture medium 215. The disc 230 is a member soaked with an inhibitor. The inhibitor acts so as to inhibit the proliferation of the culture targets on the culture medium 215. That is, the disc 230 is provided to experimentally check the inhibitor sensitivity of the culture targets to the inhibitor. Thus, in the embodiment, the disc 230 containing the inhibitor that inhibits the proliferation of the culture targets is provided on the culture medium 215.

An initial state culture medium 2151 illustrated in FIG. 8 is the culture medium 215 in which the colony has not yet appeared. When the culture targets cultured on the culture medium 215 have proliferated and a colony has appeared, an inhibition circle appears as a boundary between a proliferation area 2153 and a non-proliferation area 2152.

FIG. 9 is a schematic view illustrating an example of a state after an inhibition circle has appeared in the configuration illustrated in FIG. 8. The proliferation area 2153 illustrated in FIG. 9 is an area where the degree of light transmission exhibited at the culture medium 215 has become different from that of the initial state culture medium 2151 due to the proliferation of the culture targets cultured on the culture medium 215. The non-proliferation area 2152 is an area where the proliferation of the culture targets is inhibited by the inhibitor soaking in the disc 230. The degree of light transmission of the non-proliferation area 2152 is substantially equal to that of the initial state culture medium 2151. The non-proliferation area 2152 in FIG. 9 represents an area centered on the disc 230 where the inhibitor can inhibit the proliferation of the culture targets. The boundary between the non-proliferation area 2152 and the proliferation area 2153 is the outer peripheral edge of the area centered on the disc 230 where the inhibitor can inhibit the proliferation of the culture targets. The outer peripheral edge tends to be circular centered on the disc 230 and is called an inhibition circle. The term “inhibition circle” in the description of the embodiment refers to the inhibition circle, which is centered on the disc 230, of the proliferation of the culture targets that are cultured on the culture medium 215.

The boundary between the non-proliferation area 2152 and the proliferation area 2153 may not always be clear. The boundary is generated in a boundary area between an area of the proliferation area 2153 where a colony is significantly formed and an area of the non-proliferation area 2152 where the proliferation of the culture targets is clearly inhibited by the inhibitor. The boundary area can be an area in which the degree of light transmission exhibited at the culture medium 215 gradually changes from either the proliferation area 2153 side or the non-proliferation area 2152 side toward the other side. In the embodiment, to more clearly identify the inhibition circle within the boundary area, arithmetic processing is performed based on the intensity of light that has passed through the vicinity of the boundary between the non-proliferation area 2152 and the proliferation area 2153 and has been detected by the planar optical sensor 10. The arithmetic processing requires coordinates of a center 231 regarded as the center of the disc 230. Therefore, in the embodiment, a first process to obtain the coordinates of the center 231 and a second process to obtain the inhibition circle based on the intensity of the light detected by the planar optical sensor 10 are performed.

The first process will first be described with reference to FIG. 9. The first process includes a process to extract a circumference corresponding to the outer edge of the disc 230 using the Hough transform.

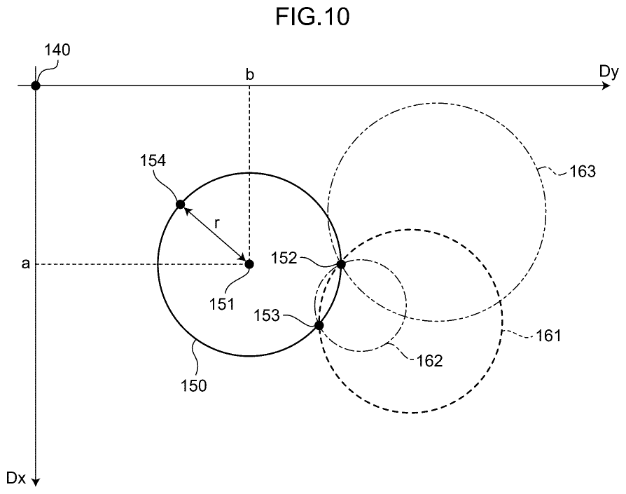

FIG. 10 is a diagram explaining the Hough transform. The description with reference to FIG. 10 assumes a case to extract a circle 150 having a radius r and centered on a point 151 in a two-dimensional space of an x-y plane having the origin at a point 140. Points 152, 153, and 154 are points located on the circumference of the circle 150.

For example, a circle having a circumference overlapping the point 152 is not limited to the circle 150; there exist countless such circles, such as circles 161, 162, and 163. Therefore, when trying to obtain a circle having a circumference overlapping the point 152, countless circles can be obtained as candidates. The circumferences of the circles 150, 161, and 162 overlap the point 153, but the circumference of the circle 163 does not overlap the point 153. Therefore, by limiting the condition for the circle to be obtained to that “the circumference overlaps the points 152 and 153”, it is possible to exclude circles, such as the circle 163, having circumferences not overlapping the point 153 from the candidates of the circle to be obtained. The circumference of the circle 150 overlaps the point 154, but the circumferences of the circles 161 and 162 do not overlap the point 154. Therefore, by limiting the condition for the circle to be obtained to “the circumference overlaps the points 152, 153, and 154”, the circle to be obtained can be limited to the circle 150. In other words, through the Hough transform, the circle 150 is extracted as a “more probable circle” that has a circumference passing through a plurality of points (such as the points 152, 153, and 154) through which the circumference of the circle to be obtained passes, with higher priority than other circles, such as the circles 161, 162, and 163.

As described with reference to FIG. 10, the Hough transform used in the embodiment is used to extract a circle having a circumference that overlaps a plurality of points. Specifically, the Hough transform extracts a circle represented by three values (a, b, r). Of these values, “a” and “b” indicate a coordinate in an x-direction and a coordinate in a y-direction in a coordinate system of Dx and Dy with respect to the origin (such as the point 140). That is, the coordinates can be expressed as (Dx, Dy)=(a, b). In FIG. 10, the coordinates expressed by (Dx, Dy)=(a, b) are the coordinates of the point 151. “r” indicates the radius r of a circle having the circle center at coordinates expressed as (Dx, Dy)=(a, b). Any point (Dx, Dy)=(X, Y) on the circumference extracted by the Hough transform can be expressed by Expression (1) below. The point 140 is, for example, at (Dx0, Dy0) as described with reference to FIG. 8.

$${r}^{2} = {( X - a )}^{2} + {( Y - b )}^{2} \qquad ( 1 )$$

The extraction of the multiple points, such as the points 152, 153, and 154 in FIG. 10, which overlap the circumference of the circle extracted by the Hough transform is performed using image processing such as the outline extraction process. Specifically, the set of the outputs from the optical sensors WA is regarded as an image. The image herein is obtained by regarding an output of one optical sensor WA as one pixel and arranging a plurality of the pixels so as to correspond to the arrangement of the optical sensors WA in the detection area SA. Hereinafter, the term simply called “image” refers to the set of the outputs of the optical sensors WA, unless otherwise noted. The term simply called “pixel” refers to the output of the optical sensor WA, unless otherwise noted. In practice, a process such as an analog-to-digital conversion is performed to regard the output of the optical sensor WA as the pixel. This process is performed by the detection circuit 15 in the embodiment as described above, but may be performed by the control circuit 30.

In the embodiment, the outline extraction process is performed on the image to extract a plurality of outlines. The outlines include an outline indicating the annular peripheral wall of the dish 210, an outline indicating the annular peripheral wall of the lid 220, an outline indicating the edge 95, and an outline indicating the outer edge of the disc 230. Each of these outlines is constituted by a plurality of annularly arranged points. Three or more of the points are arranged correspondingly to the radius r centered on the point 151, as in the case of, for example, the points 152, 153, and 154 in FIG. 10. Thus, one circle such as the circle 150 can be extracted by the Hough transform. After the outline extraction process, the Hough transform is applied to individually obtain a, b, and r for each of the outlines, and the circumference of the circle represented by the three values a, b, and r is extracted.

In most cases, the points that constitute an outline that can be regarded as one circle include a significantly greater number of points than three points. The outline extraction process is an image binarization process, such as the application of a Gaussian filter, but is not limited to this process, and may be any other image processing that can extract the outline included in the image. Additional image processing, such as application of a noise filter, may be further performed between the outline extraction process and the Hough transform to obtain the outline more accurately.

In the embodiment, the various types of processes such as the outline extraction process, the Hough transform, and the additional image processing are performed by the control circuit 30, but the present disclosure is not limited to this configuration. For example, a dedicated configuration for various extraction processes may be separately provided.

In the embodiment, the smallest outline among the above-described outlines detected in the outline extraction process is regarded as the outline indicating the outer edge of the disc 230. In the first process, the outline indicating the outer edge of the disc 230 detected in this manner is regarded as one circle, and a process to identify the center coordinates of the one circle is performed. More specifically, the one circle is formed by a sequence of a plurality of pixels included in the image. Therefore, coordinates corresponding to the midpoint between two points farthest in the first direction Dx and the midpoint between two points farthest in the second direction Dy among the pixels constituting the circle are the center coordinates of the one circle. The center coordinates are regarded as the coordinates of the center 231. Thus, the center 231 is the center of the circumference as the outer edge of the disc 230 obtained by the Hough transform.

The first process to obtain the coordinates of the center 231 is performed before the colony appears. More specifically, the first process is performed on the image (initial image) that has been obtained immediately after the object to be detected 200 in the initial state is placed on the light-transmitting member 91. The initial state is a state in which the culture targets have not yet proliferated on the culture medium 215. Therefore, at the time of the first process, the boundary between the proliferation area 2153 and the non-proliferation area 2152, as described with reference to FIG. 9, has not been generated.

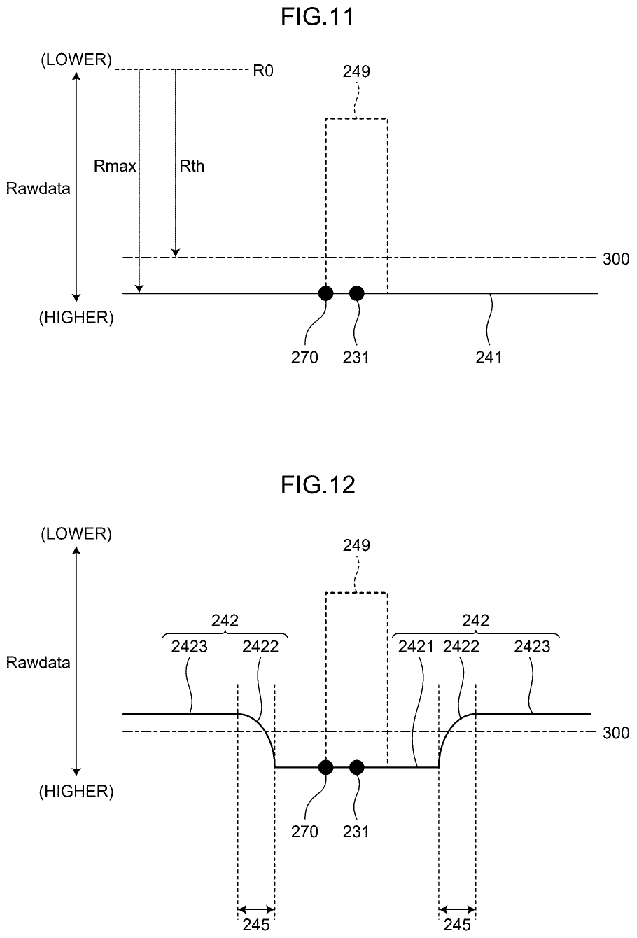

FIG. 11 is a schematic graph illustrating a distribution of levels of Rawdata indicated by an image obtained by detecting light transmitted through the culture medium 215 in the initial state. In FIG. 11 and FIG. 12 to be explained later, the arrangement direction of the pixels arranged along a line 240 illustrated in FIGS. 8 and 9 is the horizontal axis direction. That is, in FIGS. 11 and 12, the intensity of light indicated by the output of the optical sensor WA regarded as the pixel is illustrated on the vertical axis and is represented as the level of the Rawdata. The output corresponding to the detection of stronger light corresponds to the higher Rawdata. In each of FIGS. 11 and 12, the set of the outputs of the optical sensors WA regarded as the pixels is illustrated by a graph.

The initial state culture medium 2151 illustrated in FIG. 8, that is, the culture medium 215 in the object to be detected 200 in the initial state, allows more light to pass therethrough compared with the proliferation area 2153 in the culture medium 215 after a colony has appeared. Thus, the entire culture medium 215 in the initial state is the initial state culture medium 2151, exhibiting a tendency that the degree of light transmission is uniform throughout the culture medium. Therefore, as illustrated by a graph 241 in FIG. 11, the distribution of levels of the Rawdata indicated by the image obtained by detecting the light transmitted through the culture medium 215 in the object to be detected 200 in the initial state is uniformly high.

A dashed-line graph illustrated as a light-blocking area 249 is the distribution of levels of the Rawdata obtained when the disc 230 is a light-blocking disc. That is, when the disc 230 is a light-blocking disc, the Rawdata becomes low only within the light-blocking area 249 centered on the center 231. For the purpose of indicating the position of the outer edge of the disc 230, FIGS. 8, 9, and 11 and FIGS. 12 and 14 to be explained later illustrate the position of a point 270 that is a point where the line 240 intersects the outer edge of the disc 230.

The second process to obtain the inhibition circle based on the intensity of the light detected by the planar optical sensor 10 is performed after a colony has appeared. That is, the second process is performed on the image in which the boundary between the proliferation area 2153 and the non-proliferation area 2152 has been generated, as described with reference to FIG. 9.

FIG. 12 is a schematic graph illustrating the distribution of levels of the Rawdata indicated by an image obtained by detecting the light transmitted through the culture medium 215 after a colony has appeared. As illustrated in FIG. 12, the distribution of levels of the Rawdata illustrated by the image obtained by detecting the light transmitted through the culture medium 215 after a colony has appeared becomes like a graph 242 that includes a high-transmission portion 2421, a curvilinearly varying portion 2422, and a low-transmission portion 2423.

The high-transmission portion 2421 is the set of the outputs of the optical sensors WA in an area overlapping the non-proliferation area 2152 in plan view. The low-transmission portion 2423 is the set of the outputs of the optical sensors WA in an area overlapping the proliferation area 2153 in plan view. As indicated by the difference between the high-transmission portion 2421 and the low-transmission portion 2423, the Rawdata obtained as the low-transmission portion 2423 is lower than the Rawdata obtained as the high-transmission portion 2421 in the embodiment. This is because the degree of light transmission indicated by the proliferation area 2153 illustrated in FIG. 9 is lower than the degree of light transmission indicated by the non-proliferation area 2152.

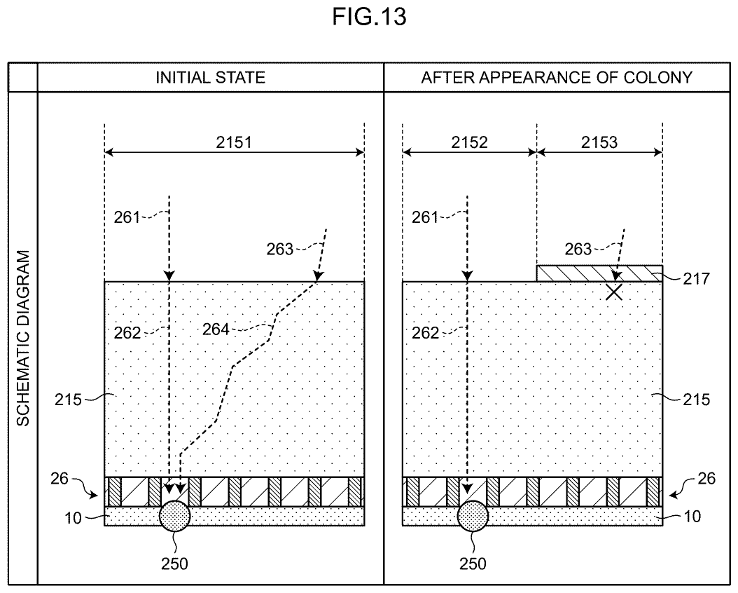

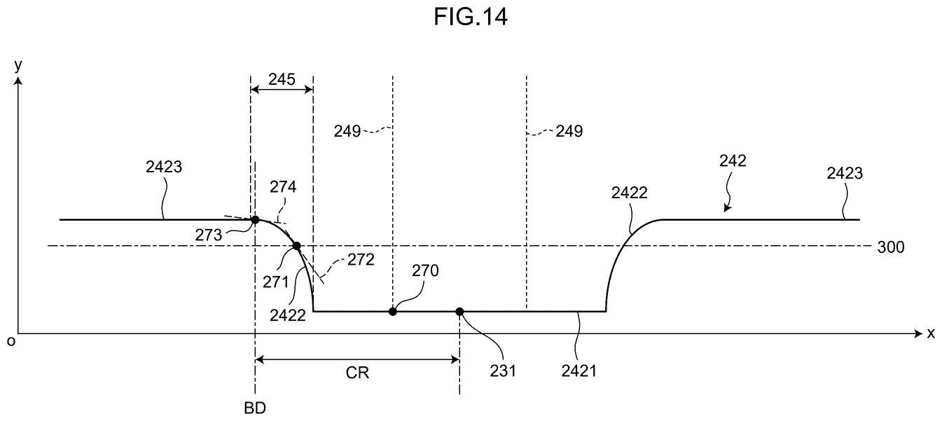

The curvilinearly varying portion 2422 is the set of the outputs of the optical sensors WA in an area overlapping the vicinity of the boundary between the non-proliferation area 2152 and the proliferation area 2153 in plan view. As described above, the boundary area between the area of the proliferation area 2153 where a colony is significantly formed and the area of the non-proliferation area 2152 where the proliferation of the culture targets is clearly inhibited by the inhibitor can be an area in which the degree of light transmission gradually changes. Therefore, as illustrated by the curvilinearly varying portion 2422 in FIG. 12, the Rawdata based on the outputs of the optical sensors WA overlapping the boundary area in plan view indicates a curvilinear variation that is lowered from the high-transmission portion 2421 toward the low-transmission portion 2423. FIG. 12 and FIG. 14 to be explained later, an area where the curvilinear change in Rawdata occurs is illustrated as a boundary area 245. A more specific mechanism by which the curvilinear change in Rawdata occurs will be described with reference to FIG. 13.

FIG. 13 illustrates schematic diagrams for comparison between paths of light reaching the planar optical sensor 10 in the initial state and the state after a colony has appeared. A position 250 illustrated in FIG. 13 indicates the position of one of the optical sensors WA provided in the planar optical sensor 10. Light 261 is light entering along the third direction Dz from a point on the culture medium 215 that overlaps the position 250 in plan view. Light 263 is light of the light entering along a direction intersecting the third direction Dz with respect to the culture medium 215. For the purpose of simplifying the explanation, the dish 210 illustrated in FIG. 7 is intentionally omitted in FIG. 13.

The culture medium 215 in the initial state is the initial state culture medium 2151, as described with reference to FIG. 8. Therefore, as illustrated in the column titled “Initial State” in FIG. 13, nothing covers a plane of incidence of the light 261 and light 263 on the culture medium 215. Therefore, the light 261 reaches the position 250 that is one of the optical sensors WA provided in the planar optical sensor 10 via a linear path such as the path 262.

The light 263 reaches the position 250 via a path such as a path 264 that includes refraction in the culture medium 215. In the embodiment, the member 26 is interposed in the light path between the culture medium 215 and the planar optical sensor 10. Therefore, not all the light entering the direction intersecting the third direction Dz with respect to the culture medium 215 can reach the position 250, and a significant amount of the light is blocked by the member 26. However, if light travels at an angle that allows the light to pass through the member 26 like the light 263 immediately before reaching the member 26, the light can reach the position 250.

In contrast to the initial state, after a colony has appeared, a proliferation layer 217 covers the proliferation area 2153 of the culture medium 215, as illustrated in the column titled “After Appearance of Colony” in FIG. 13. Thus, the light 263 that would reach the position 250 in the initial state is blocked by the proliferation layer 217 after the appearance of a colony. That is, in the state after the appearance of a colony, the intensity of the light detected by the optical sensor WA located in the position 250 becomes weaker than that in the initial state.

The degree of weakening of the intensity of the light detected by the optical sensor WA described with reference to FIG. 13 is more significant as the optical sensor WA is closer to the proliferation area 2153 in plan view. Thus, the closer to the proliferation area 2153 in plan view, the lower the Rawdata. The degree of light detection by the optical sensor WA at a location overlapping the proliferation area 2153 is weaker than the optical sensor WA overlapping the non-proliferation area 2152 in plan view because the light 261 is blocked by the proliferation layer 217. However, among the optical sensors WA at locations overlapping the proliferation area 2153 in plan view, some of the optical sensors WA located near the non-proliferation area 2152 can detect light entering through the same path as the light 263 that travels through the path 264. Nevertheless, even for the some of the optical sensors WA, the farther away from the non-proliferation area 2152, the weaker the detection degree of light that enters through the same path as that of the light 263 passing through the path 264. For these reasons, as described with reference to FIG. 12, the Rawdata based on the outputs of the optical sensors WA overlapping the boundary area in plan view exhibits a curvilinear variation that is lowered from the high-transmission portion 2421 toward the low-transmission portion 2423. The second process to obtain the inhibition circle is performed based on such a tendency of the boundary area.

The following describes more specific processing details of the second process with reference to FIG. 14. In the embodiment, the control circuit 30 mainly performs the second process, but the present disclosure is not limited thereto. For example, a dedicated arithmetic circuit separately prepared may perform the second process.

FIG. 14 is a schematic diagram for explaining a process of calculation of gradients of points constituting the curvilinearly varying portion 2422 within the boundary area 245. In FIG. 14, a coordinate system (x, y) for gradient calculation is applied to the graph (graph 242) described with reference to FIG. 12. In the coordinate system for gradient calculation, the axis along a sectional direction (line 240 in FIGS. 8 and 10) of the distribution of levels of the Rawdata illustrated by a graph such as the graph 242 is regarded as the horizontal axis (x). In the coordinate system for gradient calculation, the axis indicating the level of the Rawdata is regarded as the vertical axis (y).

In the second process, the coordinates of the center 231 are set first, based on the coordinate system for gradient calculation as illustrated in FIG. 14. Herein, the coordinates of the center 231 are set to (x, y)=(x_{c}, y_{c}). Then, a point corresponding to the output of the optical sensor WA located “at a threshold 300 or on the low-transmission portion 2423 side of the threshold 300” among the outputs of the optical sensors WA constituting the curvilinearly varying portion 2422 within the boundary area 245 is selected as the processing target of a gradient calculation process. The term “at the threshold 300 or on the low-transmission portion 2423 side of the threshold 300” refers to that the Rawdata is equal to or less than the threshold 300 (the same as or lower than the threshold 300) in terms of the levels of the Rawdata. In FIG. 14, points 271 and 273 are selectively illustrated as exemplary points that serve as the processing targets of the gradient calculation process. The points 271 and 273 are each the Rawdata indicated by the output of one optical sensor WA.

The control circuit 30 obtains the coordinates of the point that serves as the processing target of the gradient calculation process, in the coordinate system for gradient calculation. Assume that the coordinates of the point that serves as the processing target of the gradient calculation process are represented by (x, y)=(xₜ, yₜ). The control circuit 30 obtains the expression representing a straight line connecting the coordinates of two points: the center 231 and the point that serves as the processing target of the gradient calculation process. The expression representing the straight line is an expression in the coordinate system for gradient calculation. The expression can be expressed in the form of “y=ax+b” in the coordinate system for gradient calculation.

The control circuit 30 obtains the gradient (grad) at the point that serves as the processing target of the gradient calculation process using Expression (2) below. “a” in Expression (2) is “a” in “y=ax+b” that is the expression representing the straight line connecting the coordinates of the two points: the point that serves as the processing target of the gradient calculation process and the center 231. The gradient (grad) herein is that of a tangential line of the curvilinearly varying portion 2422 and is that of a line passing through the point that serves as the processing target of the gradient calculation process. For example, in FIG. 14, the line exhibiting the gradient (grad) at the point 271 is a tangential line 272. The line exhibiting the gradient (grad) at the point 273 is a tangential line 274.

$$grad = Rawdata\_bs ( {x}_{t} + 1 / \sqrt{1 + {α}^{2}} , {y}_{t} + α / \sqrt{1 + {α}^{2}} ) ) - Radata\_bs ( {x}_{t} , {y}_{t} ) \qquad ( 2 )$$

The control circuit 30 determines whether the gradient (grad) obtained by Expression (2) above is equal to or less than a predetermined value. If the gradient (grad) is not equal to or less than the predetermined value, another point farther from the center 231 in the horizontal axis direction (x) is selected as the new processing target of the gradient calculation process, and the expression (y=ax+b) and the gradient (grad) of the straight line are obtained. In other words, the point with higher priority to be the processing target of the gradient calculation process is the point corresponding to the output of the optical sensor WA positioned closer to the center 231 among the points “at the threshold 300 or on the low-transmission portion 2423 side of the threshold 300” mentioned above. Therefore, when comparing the points 271 and 273 illustrated in FIG. 14, the point 271 is more preferentially selected as the processing target of the gradient calculation process. If the gradient (grad) at a point (not illustrated) located between the points 273 and 271 and corresponding to the output of the optical sensor WA closer to the center 231 than the point 273 is not equal to or less than the predetermined value, the point 273 is selected as the processing target of the gradient calculation process.

If the processing target of the gradient calculation process at which the gradient (grad) is equal to or less than the predetermined value has been obtained, the control circuit 30 calculates the distance between the optical sensor WA corresponding to the point selected as the processing target of the gradient calculation process and the optical sensor WA corresponding to the center 231, wherein the calculated distance is regarded as a radius CR of the inhibition circle. The “distance between the optical sensor WA corresponding to the point selected as the processing target of the gradient calculation process and the optical sensor WA corresponding to the center 231” corresponds to the distance along the horizontal axis direction (x) in FIG. 14. FIGS. 9 and 14 illustrate the radius CR when the gradient (grad) at the point 273 is equal to or less than the predetermined value.

The non-proliferation area 2152 described with reference to FIGS. 9 and 13 is relatively higher in the relative levels of the degree of light transmission of the culture medium 215. The proliferation area 2153 is relatively lower in degree of light transmission. The gradient (grad) indicates the rate of change in the degree of light transmission within the boundary area (boundary area 245 illustrated in FIGS. 12 and 14) where the degree of light transmission changes curvilinearly from the non-proliferation area 2152 toward the proliferation area 2153. From these facts, the position of each of the points constituting the inhibition circle regarded as the boundary between the non-proliferation area 2152 and the proliferation area 2153 in the embodiment is closest to the non-proliferation area 2152 among the positions where the rate of change of the degree of transmission is below a certain value within that boundary area. The position of the boundary is determined within an area where Rawdata is equal to or less than the threshold (threshold 300) for determining the level of the degree of light transmission. Thus, in the embodiment, the boundary between the proliferation area and the non-proliferation area of the culture targets is determined based on the level of the degree of light transmission of the culture medium 215 that varies depending on the degree of proliferation of the culture targets that are cultured at the culture medium 215. In the example illustrated in FIG. 14, the boundary BD is generated at the location of the point 273.

“a” and “b” in “y=ax+b”, which is the expression representing the straight line connecting the coordinates of the two points: the center 231 and the point selected as the processing target of the gradient calculation process, correspond to the relation between the horizontal axis direction (x) and the vertical axis direction (y) set for convenience in the arithmetic processing by the control circuit 30. Specifically, a length based on the physical distance between the optical sensors WA in the actual detection area SA can be set in the horizontal axis direction (x). On the other hand, the vertical direction (y) corresponds to a parameter that is the level of the Rawdata. The parameter is not a physical length, and therefore, can be determined to be any value. Therefore, the value of “a” in “y=ax+b” tends to be larger as the distance between the lowest value and the highest value in the vertical direction (y) is set longer. Naturally, in the second process, the correspondence between the length in the horizontal axis direction (x) and the length in the vertical axis direction (y) is established assuming a uniquely defined setting. However, since “a” can vary depending on the setting for this reason, both the gradient (grad) obtained by Expression (2) with reference to “a” and the criterion (predetermined value) for the gradient (grad) also depend on the setting. In other words, the predetermined value is determined correspondingly to the correspondence between the length in the horizontal axis direction (x) and the length in the vertical axis direction (y). More specifically, based on the relation between the center 231 and the circle actually regarded as the inhibition circle through experiments or simulations, the correspondence between the length in the horizontal axis direction (x) and the length in the vertical axis direction (y) and the predetermined value are determined so that the point on the circumference of the circle is the point 273 in FIGS. 8 and 14. In the embodiment, the predetermined value is, for example, 0.1, but this is a specific example of the predetermined value applied in the example illustrated in FIG. 14, and the predetermined value is not limited to this value.

The value of “b” can change depending on the positional relation between the origin of y and the coordinates of the center 231, but the value of “b” is not used in Expression (2), and therefore, does not practically matter.

In FIGS. 8 and 14, the radius CR of the inhibition circle is obtained from the distance between two points of the point 273 and the center 231, but a plurality of points centered on the center 231 constitute the inhibition circle. Therefore, not only the line 240 illustrated in FIG. 9, but also any straight line passing through the center 231 can be used. Thus, a graph of the level of the Rawdata with any straight line passing through the center 231 as a section may be calculated in the same way as in FIGS. 12 and 14, and the coordinate system with reference to FIG. 14 may be set for the graph. That is, not only the point 273 in FIG. 8, but also a plurality of points, at each of which a gradient (grad) equal to or less than the predetermined value can be obtained, may be obtained. Ideally, the distances between the center 231 and the multiple points, at each of which a gradient (grad) equal to or less than the predetermined value can be obtained, should be the same as the radius CR. However, while the optical sensors WA are arranged in a matrix having a row-column configuration, the inhibition circle is circular. Therefore, the distance between the center 231 and each of the points with the gradient (grad) equal to or less than the predetermined value may not be strictly uniquely determined. In this case, the average of the distances from the multiple points to the center 231 may be determined to be the radius of the inhibition circle. In other words, to calculate the radius CR of the inhibition circle, it is only necessary to obtain at least one or more points at each of which a gradient (grad) equal to or less than the predetermined value can be obtained, and the number of the points may be one or two or more.

In the embodiment, in terms of the level of the Rawdata, all the pixels with the Rawdata equal to or less than the threshold 300 (the same as or lower than the threshold 300) are regarded as the processing targets of the gradient calculation process. That is, all the points constituting the circumference of the inhibition circle are individually identified, and then, the radius CR is calculated.

As illustrated in FIG. 4, the light source 22 includes the first light source 22R, the second light source 22G, and the third light source 22B. In the embodiment, the first light source 22R, the second light source 22G, and the third light source 22B are turned on at different times. In the embodiment, a scan process in which the optical sensor WA detects the light from the first light source 22R, the scan process in which the optical sensor WA detects the light from the second light source 22G, and the scan process in which the optical sensor WA detects the light from the third light source 22B are individually performed. The scan process is a process to obtain the image. For example, in the scan process in which the optical sensor WA detects the light from the first light source 22R, the light emitted from the first light source 22R that is on passes through the object to be detected 200, and is detected by the optical sensor WA provided in the detection area SA of the planar optical sensor 10. The processing is performed in which the output of the optical sensor WA produced by these processes is regarded as the pixel of the image.

Herein, the data of the image obtained in the scan process in which the optical sensor WA detects the light from the first light source 22R is regarded as first data. The data of the image obtained in the scan process in which the optical sensor WA detects the light from the second light source 22G is regarded as second data. The data of the image obtained in the scan process in which the optical sensor WA detects the light from the third light source 22B is regarded as third data. In the embodiment, the relation between the threshold 300 and the level of the Rawdata that serves as a starting condition for the second process only needs to be established in at least one or more of the first data, the second data, and the third data, but the starting condition for the second process is not limited to this condition. For example, the starting condition for the second process may be satisfied if at least two or all three of the first data, the second data, and the third data are satisfied. Thus, the determination of whether an area where Rawdata is equal to or less than the threshold 300 has occurred may be performed individually for the outputs of the optical sensors WA obtained with the light of the first light source 22R, the outputs of the optical sensors WA obtained with the light of the second light source 22G, and the outputs of the optical sensors WA obtained with the light of the third light source 22B. In this way, the position of the boundary can be determined under more flexible setting environments according to the optical characteristics of the culture medium 215 and the optical characteristics of the culture targets. The optical characteristics here refer to which color of light is more easily transmitted. For example, the accuracy of the determination can be more easily improved by preferentially employing light in a color having higher transmittance by the culture medium 215 and lower transmittance by the culture targets for the determination of the relation between the threshold 300 and the level of the Rawdata. In the embodiment, which color of light is used to determine the relation between the threshold 300 and the level of the Rawdata may be settable in advance. The data indicating the content of such settings is held by a storage circuit included in a configuration, such as the control circuit 30, that performs such determination or a storage circuit to which the configuration can refer.

The threshold 300 in the embodiment is determined using the degree of light transmission of the culture medium 215 in the initial state described with reference to FIGS. 8, 11, and 13 as a reference. Specifically, when the reference is 100%, the threshold 300 is determined within a range of 70% to 80% of the reference. More specifically, when a height Rmax of the graph 241 relative to a lower limit R0 of the Rawdata illustrated in FIG. 11 is 100%, a height Rth of the threshold 300 relative to the lower limit R0 is determined within the range of 70% to 80% of the height Rmax.

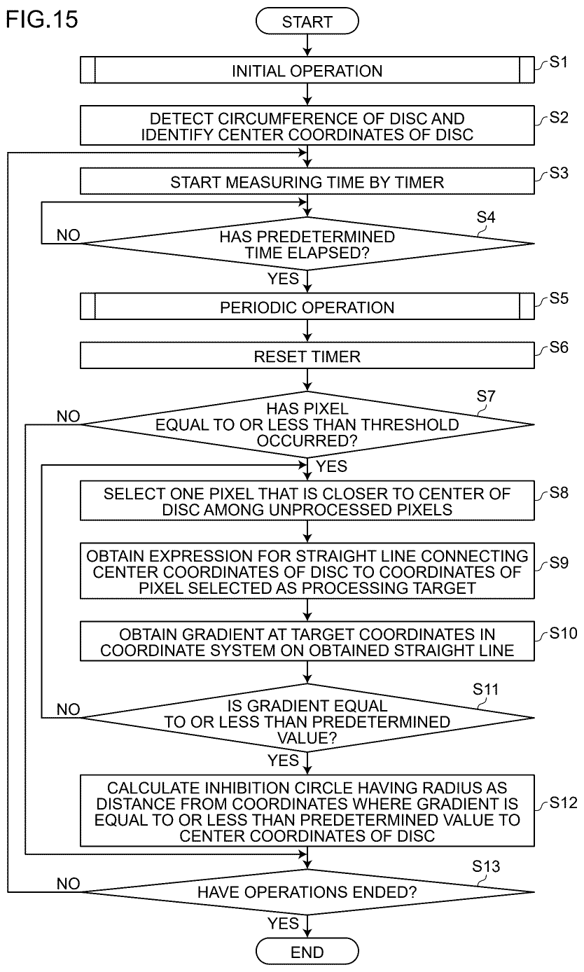

The following describes processing related to the operations of the detection device 1 with reference to flowcharts in FIGS. 15 to 17. Unless otherwise noted, in the embodiment, a process at each step illustrated in the flowcharts in FIGS. 15 to 17 is mainly performed by the control circuit 30.

FIG. 15 is a flowchart of processing related to the operations of the detection device 1. First, an initial operation is performed (Step S1). At the time of an initial process, the initial operation is performed immediately after the object to be detected 200 is placed on the detection device 1. That is, at the time of the initial process, no colonies have been formed on the culture medium 215.

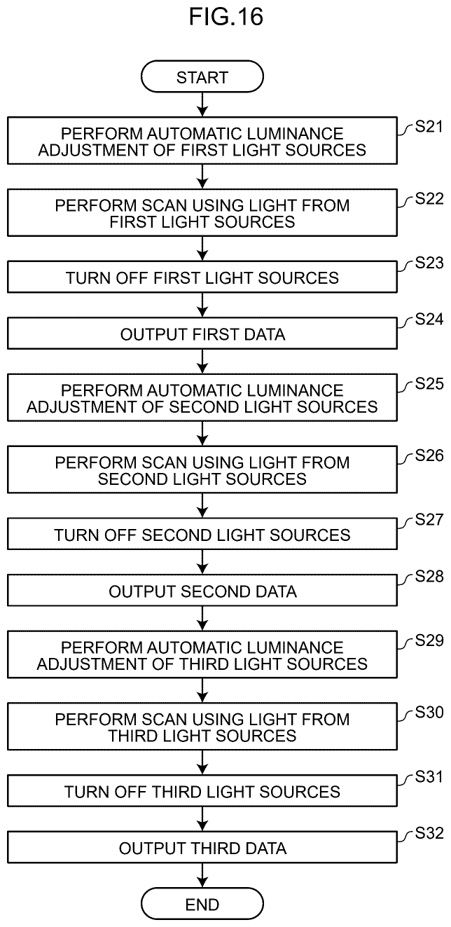

FIG. 16 is a flowchart of the initial process. First, the automatic luminance adjustment of the first light sources 22R is performed (Step S21). The automatic luminance adjustment in each of processes at Step S21 and at Steps S25 and S29 to be described later is a process to adjust the luminance of a plurality of light sources of the same color provided in the light-emitting area LA to pre-assumed luminance. The following describes an exemplary case in which the automatic luminance adjustment of a plurality of the first light sources 22R is performed in the process at Step S21. In this example, the operation is controlled such that the first light sources 22R start operating at either the lowest luminance or the highest luminance and change in luminance toward the other of the lowest luminance and the highest luminance with the lapse of time. During the lapse of the time, the detection of the light using the optical sensors WA provided in the detection area SA and the output from the optical sensors WA are periodically performed. The luminance of the first light sources 22R is regarded as the pre-assumed luminance when the outputs of the optical sensors WA becomes outputs corresponding to the pre-assumed luminance.

In the process at Step S21 in the embodiment, the luminance of the first light sources 22R is adjusted individually. Specifically, the optical sensors WA are associated with the first light sources 22R in advance as to which of the first light sources 22R is to have the pre-assumed luminance when which of the optical sensors WA has produced an output corresponding to the pre-assumed luminance. More specifically, each of the optical sensors WA detects light from the first light source 22R associated with the optical sensor WA more strongly than light from the other first light sources 22R. That is, the first light sources 22R and the optical sensors WA associated with each other are arranged so as to overlap or substantially overlap each other in plan view. The luminance of the first light source 22R is determined in this way, thus completing the automatic luminance adjustment.

In the process at each of Step S21 and Steps S25 and S29 to be described later, the control circuit 30 operates the planar optical sensor 10 and the light source panel 20 to perform the automatic luminance adjustment.

The description of a process at Step S25 to be described later is obtained by replacing the first light sources 22R in the description of the process at Step S21 with the second light sources 22G. The description of a process at Step S29 to be described later is obtained by replacing the first light sources 22R in the description of the process at Step S21 with the third light sources 22B. The specific process of the automatic luminance adjustment illustrated herein is only an example and is not limited to this example. The details may be changed as appropriate as long as the luminance of the multiple light sources of the same color can be set to the pre-assumed luminance as a result.

After the process at Step S21, the scan process using the light from the first light sources 22R is performed (Step S22). Specifically, the scan process is performed by the control circuit 30 operating the planar optical sensor 10 and the light source panel 20. In the process at Step S22, the light sources turned on by the operation of the light source panel 20 are the first light sources 22R. The second light sources 22G and the third light sources 22B are not turned on in the process at Step S22. As a result, the control circuit 30 obtains an image corresponding to the outputs of the optical sensors WA that have detected the light emitted from the first light sources 22R and transmitted through the object to be detected 200. At the completion of the process at Step S22, the first light sources 22R are turned off (Step S23).

In a process at Step S26 to be described later, the light sources to be turned on are not the first light sources 22R, but the second light sources 22G. In a process at Step S30 to be described later, the light sources to be turned on are not the first light sources 22R, but the third light sources 22B.

After the processes at Steps S22 and S23, the first data is output (Step S24).

After the process at Step S24, the automatic luminance adjustment of the second light sources 22G is performed (Step S25). After the process at Step S25, the scan process using the light from the second light sources 22G is performed (Step S26). Specifically, the scan process is performed by the control circuit 30 operating the planar optical sensor 10 and the light source panel 20. In the process at Step S26, the light sources turned on by the operation of the light source panel 20 are the second light sources 22G. The first light sources 22R and the third light sources 22B are not turned on in the process at Step S26. As a result, the control circuit 30 obtains an image corresponding to the outputs of the optical sensors WA that have detected the light from the second light sources 22G transmitted through the object to be detected 200. At the completion of the process at Step S26, the second light sources 22G are turned off (Step S27).

After the processes at Steps S26 and S27, the second data is output (Step S28).

After the process at Step S28, the automatic luminance adjustment of the third light sources 22B is performed (Step S29). After the process at Step S29, the scan process using the light from the third light sources 22B is performed (Step S30). Specifically, the scan process is performed by the control circuit 30 operating the planar optical sensor 10 and the light source panel 20. In the process at Step S30, the light sources turned on by the operation of the light source panel 20 are the third light sources 22B. The first light sources 22R and the second light sources 22G are not turned on in the process at Step S30. As a result, the control circuit 30 obtains an image corresponding to the outputs of the optical sensors WA that have detected the light from the third light sources 22B transmitted through the object to be detected 200. At the completion of the process at Step S30, the third light sources 22B are turned off (Step S31).

After the processes at Steps S30 and S31, the third data is output (Step S32).

The initial operation ends with the completion of the process at the first Step S32. As illustrated in FIG. 15, after the initial operation that is the process at Step S1, the circumference of the outer edge of the disc 230 is detected, and the coordinates of the center 231 are identified (Step S2). Specifically, by performing the first process described above, the circumference of the outer edge of the disc 230 is detected by the Hough transform, and the coordinates corresponding to the center of the circumference are identified as the coordinates of the center 231.

After the process at Step S2, a timer starts measuring time (Step S3). The process at Step S3 may be performed, for example, by a timer circuit provided in the control circuit 30, by setting a variable that serves as a counter and updating the counter based on an operating clock of the control circuit 30, or by other methods.

After the start of measuring time by the process at Step S3, a check is made to determine whether a predetermined time has elapsed (Step S4). Until the predetermined time elapses, the control circuit 30 waits (No at Step S4), without performing the next process. The predetermined time is five minutes, for example, but is not limited thereto. The predetermined time may be determined as appropriate according to a cycle (time interval) at which determination of the formation of colonies is to be made. If the predetermined time has elapsed after the process at Step S2 (Yes at Step S4), a periodic operation is performed (Step S5).

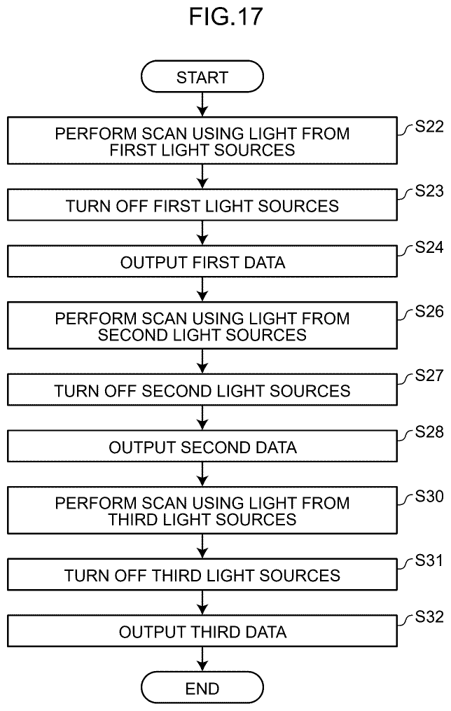

FIG. 17 is a flowchart of the periodic operation. The periodic operation is an operation in which the processes at Steps S21, S25, and S29 are omitted from the processes included in the initial operation described with reference to FIG. 16. In the periodic operation, the processes are performed in the following order: Step S22, Step S23, Step S24, Step S26, Step S27, Step S28, Step S30, Step S31, and Step S32.

The first light sources 22R, the second light sources 22G, and the third light sources 22B are turned on at different times. While one group of a group of the first light sources 22R, a group of the second light sources 22G, and a group of the third light sources 22B is on, the other two groups are not on. These light sources are periodically turned on in the order of the first light sources 22R, the second light sources 22G, and the third light sources 22B. These operations are indicated by the processes at Steps S22, S23, S26, S27, S30, and S31 in the initial operation and the periodic operation.

The luminance of the first light sources 22R that are turned on in the periodic operation is the luminance adjusted by the automatic luminance adjustment by the process at Step S21 in the initial operation. The luminance of the second light sources 22G that are turned on in the periodic operation is the luminance adjusted by the automatic luminance adjustment by the process at Step S25 in the initial operation. The luminance of the third light sources 22B that are turned on in the periodic operation is the luminance adjusted by the automatic luminance adjustment by the process at Step S29 in the initial operation.

The periodic operation ends with the completion of the process at Step S32 at the second and subsequent times. As illustrated in FIG. 15, after the periodic operation that is the process at Step S5, the timer is reset (Step S6). That is, the timer that started measuring time at Step S3 is reset in the process at Step S6.

The control circuit 30 determines, from the viewpoint of the level of the Rawdata indicated by the output of the optical sensor WA, whether a pixel equal to or less than the threshold 300 has occurred in the image obtained in the periodic operation at Step S5 (Step S7). If a pixel equal to or less than the threshold 300 is determined to have occurred (Yes at Step S7), the control circuit 30 selects one pixel that is closer to the center 231 from among the unprocessed pixels that are equal to or less than the threshold 300 and for which the gradient (grad) has not yet been obtained (Step S8). The pixel to be selected at Step S8 is, in other words, the processing target of the gradient calculation process described above.

The control circuit 30 obtains the coordinates of the pixel (point) selected as the processing target of the gradient calculation in the coordinate system for gradient calculation described with reference to FIG. 14. The control circuit 30 obtains the expression representing the straight line connecting the coordinates of the two points: the center 231 and the point selected as the processing target of the gradient calculation process (Step S9). The control circuit 30 obtains the gradient (grad) at the point selected as the processing target of the gradient calculation process using Expression (2) described above (Step S10).

The control circuit 30 determines whether the gradient (grad) obtained in the process at Step S10 is equal to or less than the predetermined value (Step S11). If it is determined that the gradient (grad) is not equal to or less than the predetermined value (No at Step S11), the process at Step S8 is performed again. That is, the processes at Steps S9 and S10 are performed using one of the unprocessed pixels that are equal to or less than the threshold 300 and for which the gradient (grad) has not yet been obtained, as the new processing target of the gradient calculation.

In the process at Step S11, if it is determined that the gradient (grad) is equal to or less than the predetermined value (Yes at Step S11), the inhibition circle having the radius CR as the distance between the center 231 and the optical sensor WA corresponding to the coordinates where the gradient (grad) is equal to or less than the predetermined value is obtained (Step S12). The processes from Step S7 to Step S12 correspond to the second process described above.

If, after the process at Step S12 or in the process at Step S7, it is determined that the pixel equal to or less than the threshold 300 has not occurred (No at Step S7), the process at Step S3 is performed again unless the operations of the detection device 1 have ended (No at Step S13). That is, the timer measures time again; and the periodic operation, the resetting of the timer, and the processing related to the determination of the position of the boundary forming the inhibition circle are performed each time the predetermined time elapses. If it is determined in the process at Step S13 that the operations of the detection device 1 have ended (Yes at Step S13), the processing related to the operations of the detection device 1 ends. Even if all of the pixels equal to or less than the threshold 300 are selected as the processing target of the gradient calculation, but no coordinates are present where the gradient (grad) is equal to or less than the predetermined value, the control circuit 30 exits from a series of looped processes from Step S8 to Step S12 and proceeds to the process at Step S13.

As described above, according to the embodiment, the detection device 1 includes the light sources (light sources 22) that emit light, the planar optical sensor (planar optical sensor 10) in which the optical sensors (optical sensors WA) that detect the light from the light sources are two-dimensionally arranged, the object placement part (object placement part 99) that is provided so as to allow the object to be detected (object to be detected 200) to be placed such that the object to be detected is interposed between the light sources and the planar optical sensor, and the processor (control circuit 30) that performs the operation control of the light sources and the planar optical sensor and the processing based on the outputs of the optical sensors. The object to be detected is the culture medium (culture medium 215) accommodated in the dish (dish 210) of the container. The planar optical sensor outputs the data reflecting the intensity of the light that is emitted from the light sources and reaches the optical sensors through the object to be detected. The processor determines the boundary between the proliferation area and the non-proliferation area of the culture targets (for example, the boundary BD illustrated in FIG. 14) based on the level of the degree of light transmission of the culture medium that varies according to the degree of proliferation of the culture targets that are cultured on the culture medium. The boundary is in the position (for example, position of the point 273 illustrated in FIG. 14) that is closest to the position where the rate of change in degree of light transmission is relatively highest among positions where the rate of change in degree of light transmission is equal to or less than the predetermined value within the area where the degree of light transmission of the culture medium changes from the relatively higher side toward the relatively lower side (for example, the boundary area 245 illustrated in FIGS. 12 and 14). With these configurations, in the embodiment, the boundary can be more clearly identified even when the boundary does not necessarily appear as a clear line in the image.

In the embodiment, the position of the boundary between the proliferation area and the non-proliferation area of the culture targets is determined within the area where the degree of light transmission of the culture medium (culture medium 215) is equal to or less than the threshold (for example, the threshold 300 illustrated in FIGS. 11, 12, and 14). In addition, the threshold is determined using the degree of light transmission of the culture medium in the initial state before the proliferation of the culture targets as a reference. With these configurations, the area for determining the position of the boundary and the threshold for limiting the area can be determined more clearly. Therefore, the position of the boundary can be determined based on clearer rules.

In the embodiment, the threshold (for example, the threshold 300 illustrated in FIGS. 11, 12, and 14) is determined within the range of 70% to 80% of a reference, where the reference is set at 100%, representing the degree of light transmission of the culture medium (culture medium 215) in the initial state. Thus, the threshold can be determined by clearer rules. Therefore, the position of the boundary between the proliferation area and the non-proliferation area of the culture targets can be determined with clearer rules.

In the embodiment, the disc (disc 230) containing the inhibitor that inhibits the proliferation of the culture targets is provided to the culture medium (culture medium 215). The boundary between the proliferation area and the non-proliferation area of the culture targets is the inhibition circle for the proliferation of the culture targets centered on the disc. Thus, the position of the boundary is determined and identified, thereby allowing the inhibition circle to be identified.

In the embodiment, the center of the disc (disc 230) containing the inhibitor that inhibits the proliferation of the culture targets is the center of the circumference as the outer edge of the disc obtained by the Hough transform. Thus, the center of the disc can be more clearly defined based on the output of the planar optical sensor (planar optical sensor 10).

In the embodiment, the light sources (light sources 22) include the first light sources (first light sources 22R) that emit light in a first color, the second light sources (second light sources 22G) that emit light in a second color, and the third light sources (third light sources 22B) that emit light in a third color. The determination of whether an area has occurred where the degree of light transmission of the culture medium (culture medium 215) is equal to or less than the threshold (for example, the threshold 300 illustrated in FIGS. 11, 12, and 14) is performed individually for the outputs of the optical sensors (optical sensors WA) obtained using the light of the first light sources, the outputs of the optical sensors obtained using the light of the second light sources, and the outputs of the optical sensors obtained using the light of the third light sources. As a result, the position of the boundary can be determined under more flexible setting environments according to the optical characteristics of the culture medium and the optical characteristics of the culture targets.

In the embodiment, the optical member (member 26) is provided between the planar optical sensor (planar optical sensor 10) and the light sources (light sources 22) to limit the traveling direction of the light emitted from the light sources and reaching the planar optical sensor to a direction (third direction Dz) orthogonal to the surface for detecting the light by the planar optical sensor and a direction having a shallower inclination angle with respect to the orthogonal direction. This makes it easier to produce a more clearly defined range (e.g., the boundary area 245 illustrated in FIGS. 12 and 14) in which the degree of light transmission of the culture medium (culture medium 215) changes from relatively high to relatively low.

Furthermore, as illustrated in FIG. 7, the object to be detected 200 is placed on the light-transmitting member 91 in the state where the dish 210 with the culture medium 215 therein is provided at the upper position relative to the lid 220 and the lid 220 is provided at the lower position relative to the dish 210. This arrangement can reduce the upward movement and condensation of moisture evaporated from the culture medium 215. Drying of the culture medium 215 can be inhibited, and better imaging and the like of the culture medium 215 can be achieved.

In the embodiment, the light sources 22 including the first light sources 22R, the second light sources 22G, and the third light sources 22B are employed as light sources, but the light sources that can be employed in the embodiment according to the present disclosure are not limited to such light sources. For example, light sources corresponding to light in four or more colors of light may be employed, or light sources corresponding to one or two colors of light may be employed. Light in combined colors may also be used by simultaneously turning on some or all of a plurality of types of light sources that emit light in different colors. For example, when the first light sources 22R, the second light sources 22G, and the third light sources 22B are simultaneously turned on, white light is obtained.

The relative positional relation in the up-and-down direction between the planar optical sensor 10 and the light source panel 20 is not limited to the example illustrated in FIG. 7, and may be opposite to the relation illustrated in FIG. 7. The elastic member 93 is not essential to the object placement part 99. For example, the light-blocking member 92 may be fixed to the housing 90 so that the light-transmitting member 91 is interposed between the planar optical sensor 10 and the light source panel 20. In this case, a gap allowing the object to be detected 200 to be inserted therein is provided above the light-transmitting member 91, between the light-transmitting member 91 and the planar optical sensor 10 or the light source panel 20.

Although the lid 220 is not essential in the object to be detected 200, the lid 220 is more preferably provided in order to reduce the entry of foreign matter in the culture medium 215. The dish 210 of the embodiment is the Petri dish, but is not limited thereto, and may be another component that serves in the same way as the Petri dish.

Other operational advantages accruing from the aspects described in the present embodiment that are obvious from the description herein, or that are conceivable as appropriate by those skilled in the art will naturally be understood as accruing from the present disclosure.

What is claimed is:

1. A detection device comprising:
a light source configured to emit light;
a planar optical sensor in which a plurality of optical sensors configured to detect the light from the light source are two-dimensionally arranged;
an object placement part provided so as to allow an object to be detected to be placed such that the object to be detected is interposed between the light source and the planar optical sensor; and
a processor configured to perform operation control of the light source and the planar optical sensor and processing based on outputs of the optical sensors, wherein
the object to be detected is a culture medium accommodated in a dish of a container,
the planar optical sensor is configured to output data reflecting an intensity of the light that has been emitted from the light source and reached the optical sensors through the object to be detected, and
the processor is configured to determine a boundary between a proliferation area and a non-proliferation area of culture targets based on a level of a degree of light transmission of the culture medium that varies according to a degree of proliferation of the culture targets that are cultured on the culture medium, and
the boundary is in a position that is closest to a position where a rate of change in the degree of light transmission of the culture medium is relatively highest among positions where the rate of change in the degree of light transmission of the culture medium is equal to or less than a predetermined value within an area where the degree of light transmission of the culture medium changes from a relatively higher side toward a relatively lower side.

2. The detection device according to claim 1, wherein
the position of the boundary is determined within an area where the degree of light transmission of the culture medium is equal to or less than a threshold, and
the threshold is determined using, as a reference, the degree of light transmission of the culture medium in an initial state before the proliferation of the culture targets.

3. The detection device according to claim 2, wherein the threshold is determined within a range of 70% to 80%, when the reference is 100%.

4. The detection device according to claim 1, wherein
a disc containing an inhibitor that inhibits the proliferation of the culture targets is provided to the culture medium, and
the boundary is an inhibition circle for the proliferation of the culture targets that is centered on the disc.

5. The detection device according to claim 4, wherein a center of the disc is a center of a circumference as an outer edge of the disc obtained by the Hough transform.

6. The detection device according to claim 2, wherein
the light source comprises:
a first light source configured to emit light in a first color;
a second light source configured to emit light in a second color; and
a third light source configured to emit light in a third color, and
determination of whether an area where the degree of light transmission is equal to or less than the threshold has occurred is performed individually for:
outputs of the optical sensors obtained with light of the first light source;
outputs of the optical sensors obtained with light of the second light source; and
outputs of the optical sensors obtained with light of the third light source.

7. The detection device according to claim 1, wherein an optical member is provided between the planar optical sensor and the light source to limit a traveling direction of the light emitted from the light source and reaching the planar optical sensor to a direction orthogonal to a surface for detecting the light by the planar optical sensor and a direction having a shallower inclination angle with respect to the orthogonal direction.
